(19) United States
(12) Patent Application Publication
(10) Pub. No.: US 2021/0256478 A1
(43) Pub. Date: Aug. 19, 2021

(54) METHOD AND SYSTEM FOR RECRUITING CANDIDATES

(71) Applicant: ANGELA HOOD, Austin, TX (US)

(72) Inventor: ANGELA HOOD, Austin, TX (US)

(21) Appl. No.: 17/254,342

(22) PCT Filed: Jun. 21, 2019
(86) PCT No.: PCT/IB19/55274

§ 371 Date: Dec. 21, 2020

(30) Foreign Application Priority Data
Jun. 21, 2018 (GB) 1810196.4

(51) Int. Cl. G06Q 10/10; G06N 20/00; G06N 5/04; G06F 21/62

(52) U.S. Cl. CPC G06Q 10/1053; G06N 20/00; G06Q 50/265; G06F 21/6245; G06Q 2220/10; G06N 5/04

(57) ABSTRACT

Mapping at least one job opening provided by at least one recruiter company to candidate profiles includes receiving information describing a given candidate and analyzing the information describing the candidate, assigning a first set of values to the information describing the given candidate by applying at least one logic function to the information, defining a second set of values based on the at least one logic function, and generating a third set of values by applying at least one cross correlation function to the first set of values and the second set of values. The method further comprises ranking the given candidate to the at least one job opening by applying at least one ranking function, and recommending the at least one job opening to the given candidate. Beneficially, the method is implemented using a block chain arrangement supervised using a distributed ledger arrangement, wherein data encryption is employed to protect candidate person data when communicated within the block chain arrangement.

### TECHNICAL FIELD

The present disclosure relates generally to computing platforms that provide a secure (for example, encrypted) environment for implementing job searching services, for example utilizing blockchains utilizing encryption for ensuring protected personal data; more particularly, the present disclosure relates to a system and a method that maps at least one job opening provided by at least one recruiter company to a candidate profile in manner that provides personal data security.

### BACKGROUND

Over the past few years, job seekers and recruiting companies have increasingly relied on centralized databases, such as Internet® web sites, to match the job seekers with the recruiting companies. A most common contemporary practice among the recruiting companies is to prepare a job description for each job opening, and then to publish the job opening along with the job description in print and digital media on some Internet® web sites. The job seekers also provide their resumes to these Internet® web sites. However, these Internet® web-sites can be prone to hacking by malicious third parties, and candidates' personal data held at the centralized databases can potentially be compromised by such hacking.

These web sites are supported by computing hardware and servers that map the information disclosed by the job seekers in their resumes to the job description for finding the best job for the job seeker. The information disclosed by the job seekers in their resumes comprises qualifications, hobbies and interests, skills and so forth, which often looks identical for different job seekers. Further, analyzing the resumes and finding the best job for the job seeker is extremely difficult. Currently available job search tools take into account only explicit information provided by the job seekers in their resumes. However, such job search tools do not consider non-explicit information such as traits of the job seeker, such as personality characteristics, personal features such as being introvert and so forth. Furthermore, the currently available contemporary job search tools are set to link manually, the job seekers and their resumes to job titles posted by the recruiting companies. This is typically done by matching a degree (for example, Law), a title given by experience (for example, shop manager) or a self-appointed title (for example, intellectual property agent) to a job title required by the recruiter company posting a job.

A typical given job seeker applies for multiple job offers and shares his/her data with a plurality of recruiters in various forms; the data includes, for example, resume, curriculum vitae, online forms or social media profile links. It is usual that there is a lack of relevant feedback for the given job seeker during the online application process, for example feedback regarding when the given job seeker's data is being accessed by one or more recruiting companies. For example, job seekers are often not notified when, and in what form, their data is accessed and viewed by one or more recruiting companies. The lack of such feedback to the given job seeker raises a feeling of uncertainty and suspense for the given job seeker.

For recruiting companies, anonymity is required at times; protecting personal data of the given job seeker is also an important consideration to comply with various laws regarding protection of personal data.

Therefore, in light of the foregoing discussion, there exists a need to overcome the aforementioned drawbacks associated with conventional techniques of searching for a job for a job seeker.

### SUMMARY

The present disclosure seeks to provide an improved method for mapping at least one job opening provided by at least one recruiter company to candidate profiles, for example in a secure manner using data encryption.

Moreover, the present disclosure further seeks to provide an improved system of mapping at least one job opening provided by at least one recruiter company to candidate profiles, for example in a secure manner using data encryption.

In an aspect, the present disclosure provides a method for (of) mapping at least one job opening provided by at least one recruiter company to candidate profiles, the method comprising:
receiving information describing a given candidate;
analyzing the information describing the candidate, wherein the analyzing comprises:
   assigning a first set of values to the information describing the given candidate by applying at least one logic function to the received information;
   defining a second set of values based on the at least one logic function, wherein the second set of values comprises profile, traits and answers to questions asked from the given candidate; and
   generating a third set of values by applying at least one cross correlation function to the first set of values and the second set of values, wherein the third set of values are match score values between the candidate profiles and the at least one job opening;
ranking the given candidate to the at least one job opening by applying at least one ranking function; and
recommending the at least one job opening to the given candidate.

Optionally, the method further comprises storing the information describing the given candidate, for example in an encrypted format. More optionally, the information is provided in a corpus of data comprising a plurality of data parts, wherein mutually different encryption algorithms with mutually different encryption keys are employed to protect each of the plurality of data parts, so that the at least one recruiting company is susceptible to being provided with controlled access to at least one of the data parts by being provided with at least a subset of the encryption keys pertaining to the at least one of the data parts. Optionally, the encryption is time-limited so that the encryption keys provide only a time-limited access to the at least one data part.

Optionally, the information describing the given candidate comprises a first set of information, wherein the first set of information comprises at least one of designation, experience, current salary, expected salary and qualifications.

More optionally, the information describing the given candidate comprises a second set of information, wherein the second set of information comprises personal traits and skills of the candidate.

Optionally, the method further comprises sending the match score values describing the given candidate to the at least one recruiter company providing the at least one job opening.

Optionally, the method further comprises receiving feedback regarding the given candidate from the at least one recruiter company.

Optionally, the method further comprises updating the information based on the feedback from the at least one recruiter company.

In another aspect, an embodiment of the present disclosure provides a system of mapping at least one job opening provided by at least one recruiter company to candidate profiles, the system comprising:
a server having a job matching system, wherein the job matching system has a given candidate and the at least one recruiter company connected thereto when in operation using respective computing devices through a data communication network, the job matching system comprises:
   a transceiving module for receiving information describing the given candidate;
   an analyzing module for:
      analyzing the information describing the given candidate;
      assigning a first set of values to the information describing the given candidate by applying at least one logic function to the received information;
      defining a second set of values based on the at least one logic function, wherein the second set of values comprises profile, traits and answers to questions asked from the given candidate; and
      generating a third set of values by applying at least one cross correlation function to the first set of values and the second set of values, wherein the third set of values are match score values between the candidate profiles and the at least one job opening;
   a ranking module for ranking the given candidate to the at least one job opening by applying at least one ranking function; and
   a recommendation module for recommending the at least one job opening to the given candidate.

Optionally, the job matching system further comprises a database for storing the information describing the given candidate, for example in an encrypted format. More optionally, the information is provided in a body of data comprising a plurality of data parts, wherein mutually different encryption algorithms with mutually different encryption keys are employed to protect each of the plurality of data parts, so that the at least one recruiting company is susceptible to being provided with controlled access to at least one of the data parts by being provided the at least one recruiting company with at least a subset of the encryption keys pertaining to the at least one of the data parts. Optionally, the encryption keys are time-limited, so that the encryption keys provide only a time-limited access to the at least one data part. Optionally, public-private key encryption is employed, alternative a combination of encryption and data obfuscation algorithm whose operation is controlled through the use of data maps.

Optionally, the information describing the given candidate comprises a first set of information, wherein the first set of information comprises at least one of designation, experience, current salary, expected salary and qualifications.

More optionally, the information describing the given candidate comprises a second set of information, wherein the second set of information comprises personal traits and skills of the given candidate.

Optionally, the transceiving module is further operable to send the match score values associated with the given candidate to the at least one recruiter company providing the at least one job opening.

Optionally, the transceiving module is operable to receive feedback regarding the given candidate from the at least one recruiter company.

Optionally, the analyzing module is operable to update the information based on the feedback from the at least one recruiter company.

Optionally, the job matching system further comprises:
a version control of the job description, the company profile and the candidate profile;
a verification tool for preventing overwriting of candidates' records that have some credentials that are matched to at least one job description;
a “de-duping” arrangement to prevents a duplication of a given candidate record;
a “most recent” arrangement that enables data to be removed (“pulled”) from an older version of a duplicated profile (for example, by use of the aforesaid version control).

Optionally, the features of job matching system is implemented using a block chain arrangement whose operation is coordinated through use of a distributed ledger arrangement, wherein the block chain arrangement is hosted in a data communication network including a plurality of data servers and user nodes that, when in operation, exchange data therebetween. Optionally, the distributed ledger arrangement supports operation of a block chain arrangement by use of encryption-hash verification of each new block added to the block chain that is verifiable from a previous block of the block chain to be bona fide. Optionally, each block represents a given job or a given candidate to ensure that a given job is not eventually allocated to more than one candidate, or a candidate is not allocated to more than one given job, unless job-share and/or part-time working is permitted in relation to the candidates and jobs. The distributed ledger keeps a record of the blocks of the block-chain. Data exchange in the block chain arrangement is beneficially implemented in an encrypted manner to protect personal information of job seekers, and to render the block chain arrangement resilient to malicious third-party hackers.

### BRIEF DESCRIPTION OF THE FIGURES

The foregoing summary, as well as the following detailed description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIGS. 1A-1B are schematic illustrations of various exemplary systems for mapping at least one job opening provided by at least one recruiter company to candidate profiles, in accordance with various embodiments of the present disclosure;

FIG. 2 is a block diagram of a server having a job matching system, in accordance with an embodiment of the present disclosure;

FIG. 3 is a block diagram of a computing device associated with a candidate and the at least one recruiter company, in accordance with an embodiment of the present disclosure;

FIG. 4 is an illustration of steps of a method for mapping the at least one job opening provided by the at least one recruiter company to the candidate profiles, in accordance with an embodiment of the present disclosure;

FIG. 5A-5B is a detailed illustration of steps of the method for mapping the at least one job opening provided by the at least one recruiter company to the candidate profiles, in accordance with an embodiment of the present disclosure; and

FIG. 6 is an exemplary implementation of information flow in the system for mapping the at least one job opening provided by the at least one recruiter company to the candidate profiles, in accordance with an embodiment of the present disclosure.

### DETAILED DESCRIPTION

Description of embodiments of the present disclosure is not intended to limit the scope of claims of the present disclosure. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Functional units described in this disclosure have been labeled as systems or devices. A module, device, or a system may be implemented in programmable hardware devices such as, processors, digital signal processors, central processing units, field programmable gate arrays, programmable array logic, programmable logic devices, cloud processing systems, or the like. The devices/modules may also be implemented in software for execution by various types of processors. An identified device/module may include executable code and may, for example, comprise one or more physical or logical blocks of computer instructions, which may be, for example, organized as an object, procedure, function, or other construct. Nevertheless, the executable of an identified device/module need not be physically located together, but may comprise disparate instructions stored in different locations which, when joined logically together, comprise the device and achieve the stated purpose of the device.

Indeed, an executable code of a device could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

It will be appreciated that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

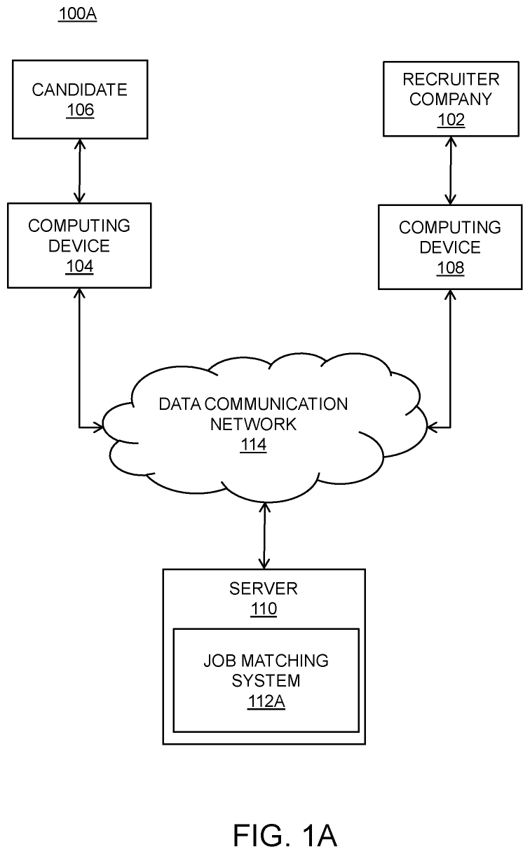

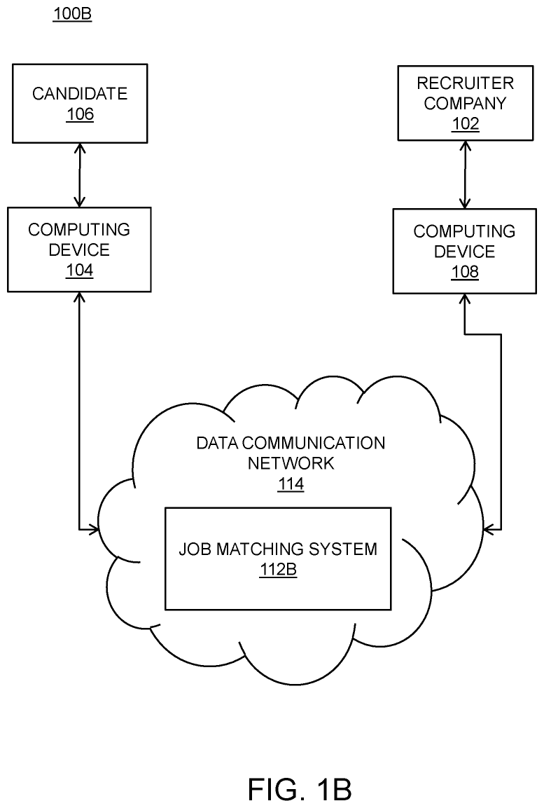

In FIGS. 1A-1B, there a provided schematic illustrations of various exemplary systems 100A-100B for mapping at least one job opening provided by at least one recruiter company, such as a recruiter company 102 to candidate profiles, in accordance with various embodiments of the present disclosure. As shown in FIG. 1A, the system 100A includes a computing device 104 associated with a candidate 106 and a computing device 108 associated with the recruiter company 102.

In an embodiment, the candidate 106 is a job seeker looking for a job change or a fresher looking for his/her first job. The recruiter company 102 is an organization having at least one job opening and is willing to hire candidates (such as the candidate 106). Alternatively, the recruiter company 102 may be a job consultancy company associated with at least one organization providing the at least one job opening to the candidate 106.

In an embodiment, the at least one job opening may be associated with any field of work, including sales, engineering, marketing, software developing, accounting, medicine, hospitality, aviation, cooking, fashion designing, law, police and so forth.

The system 100A further comprises a server 110. The server 110 further includes a job matching system 112A. According to an embodiment, the server 110 generally refers to an application, program, process or device that responds to requests for information or services by another application, program, process or device on a communication network, such as a data communication network 114. According to another embodiment, the server 110 also encompasses software that makes an act of serving information or providing services possible.

In the present embodiment, the candidate 106 and the recruiter company 102 communicates with the server 110 (particularly, with the job matching system 112A present therein) using the computing devices 104 and 108 respectively and via the data communication network 114; beneficially, data communicated via the data communication network 114 is in a data-protected format, for example at least partially encrypted. Optionally, mutually different degrees of data protection are employed for mutually different types of data being exchanged between the computing devices 104, 108, to resist third-party eavesdropping or hacking. Specifically, the candidate 106 and the recruiter company 102 are registered with the job matching system 112A for getting a suitable job and a suitable candidate for their job opening, respectively. It may be evident to those skilled in the art that there can be multiple candidates and recruiter companies registered with the job matching system 112A; optionally, the multiple candidates and recruiter companies are issued with encryption passwords that limit their access to information communicated in the system 100A, for example to control distribution of sensitive personal data of the multiple candidates, to comply with national law regarding use of personal data.

In an embodiment, the computing devices 104 and 108 may include cell phones, phablet computers, tablet computers, desktop computers, personal digital assistants (PDA), and so forth. A typical example of the computing devices 104 and 108 is a wireless data access-enabled device, for example, an iPHONE® smart phone, a BLACKBERRY® smart phone, a NEXUS ONE™ smart phone, an iPAD® device, and so forth, that is capable of sending and receiving data in a wireless manner using protocols like the Internet Protocol (IP), and the wireless application protocol (WAP).

In an embodiment, the data communication network 114 can be wired, wireless or a combination thereof. According to an embodiment, the communication network 114 includes, but is not limited to, Local Area Networks (LANs), Wide Area Networks (WANs), Metropolitan Area Networks (MANs), Wireless LANs (WLANs), Wireless WANs (WWANs), Wireless MANS (WMANs), the Internet, second generation (2G) telecommunication networks, third generation (3G) telecommunication networks, fourth generation (4G) telecommunication networks, and Worldwide Interoperability for Microwave Access (WiMAx) networks.

In operation, the job matching system 112A is operable to receive information describing the given candidate 106. According to one embodiment, the information describing the given candidate comprises a first set of information. The first set of information comprises at least one of designation, experience, current salary, expected salary and qualifications. In the system 110A, such information is beneficially selectively encrypted, for example encrypted in nested layers, so that control of information within the system 100A can be selectively controlled via selective distribution of encryption and decryption keys.

According to another embodiment, the information describing the given candidate comprises a second set of information. The second set of information comprises personal traits and skills of the given candidate 106. In an embodiment, the traits are the characteristics of the candidate 106 including, but not limiting to, energetic, inventive, responsible, optimistic, reliable, introvert, extrovert and disciplined. The skills of the candidate 106 comprise technical skills, including for example, knowledge of a particular programming language, scripting language, networking protocols and so forth when the candidate 106 is associated with information technology (IT), and so forth.

The job matching system 112A is operable to receive information describing the at least one job opening by the recruiter company 102. The information describing the at least one job opening comprises job description, desired traits and skills in candidates.

Further, the job matching system 112A is operable to receive the information manually, i.e. by asking the candidate 106 and the recruiter company 102 to provide the information. For example, the candidate 106 provides his/her resume to the job matching system 112A and the recruiter company 102 provides the at least one job opening and job description to the job matching system 112A. The resume provided by the candidate 106 provides the first set of information. For determining the second set of information, the job matching system 112A provides a web page to the candidate 106 and the recruiter company 102 asking a number of questions from the candidate 106 and the recruiter company 102. Specifically, the job matching system 112A is operable to propose questions to the candidate 106, such as related to, hobbies and interests, skills, likes/dislikes, general awareness and so forth. Based upon answers to the questions, the job matching system 112A determines the second set of information describing the candidate 106. On the other hand, the job matching system 112A is operable to propose questions to the recruiter company 102, such as type/domain of the job opening, designation for which the recruiter company 102 wants to hire, salary that the recruiter company 102 wants to provide to a new candidate, desired traits and so forth.

Alternatively, the job matching system 112A is operable to receive the information via an automated way from a third-party website, such as LinkedIn®, Facebook® and so forth.

The job matching system 112A is further operable to store the information describing the given candidate 106 and the recruiter company 102. Further, the job matching system 112A is operable to analyze the information describing the given candidate 106 and the recruiter company 102. Specifically, the job matching system 112A is operable to assign a first set of values to the information describing the given candidate 106 by applying at least one logic function to the received information. The first set of values includes numbers, words, sets or combinations thereof. In a preferred embodiment, the first set of values includes comparable values, such as high, medium, and low. The at least one logic function are algorithms used for linking/assigning the first set of values to the each piece of information describing the given candidate 106. The first set of values are used for storing and retrieving the information to and from a database.

The job matching system 112A is operable to define a second set of values based on the at least one logic function. The second set of values comprises profile, the traits and answers to questions asked from the given candidate 106. The term “profile” or “professional profile” refers to identified skills of the candidate 106, aptitude of the candidate 106, his/her work-related information and so forth. In an embodiment, the professional profile is an online dynamic document which is updated directly by at least one of the candidate 106 and the job matching system 112A (for example, via a learning algorithm, described herein later). In an embodiment, the second set of values are defined according to a pre-defined logic, such as based on answers to the questions asked from the candidate 106. For example, if the question asked from the candidate 106 was “which color do you prefer?” and the candidate 106 replied grey, then the second set of value assigned may be 2 out of a range of 1-10, where 1 represents a sad person and 10 represents a happy person. The second set of values thus are useful for defining a trait or personality aspect of the candidate 106. In an embodiment, the job matching system 112A is operable to define profiles, desired traits from the answers provided by the recruiter company 102.

Further, the job matching system 112A is operable to generate a third set of values by applying at least one cross correlation function to the first set of values and the second set of values. Specifically, the at least one cross correlation function is applied on the traits and professional profile of the candidate 106. The third set of values are match score values between the candidate' s 106 profile and the at least one job opening. The term “cross-correlation function” refers to a measure of similarity between the candidate's 106 profile and the at least one job opening. Specifically, the cross-correlation function is an algorithm used for comparing the candidate's 106 profile and the at least one job opening, particularly, for comparing the traits and skills of the candidate 106 to the desired traits and skills by the recruiter company 102. In an embodiment, the similarity between the candidate profile and the at least one job opening is not only determined based on the first set of information, but also takes into consideration the second set of information, based upon which the match score values are generated. The match score values can be numbers, words, sets or combinations thereof. In an exemplary embodiment, the match score values are values ranging from 0-5, where 0 represents no similarity and 5 represents maximum similarity. In another exemplary embodiment, the match score values are comparable values, such as high, medium, and low. For example, if the question asked from the candidate 106 was “Are you willing to relocate?” and the candidate 106 replied no, then the cross correlation function is applied to make intermediate desired matches, for example, filtering job openings based upon city of choice of the candidate 106.

The job matching system 112A is operable to send the match score values associated with the given candidate 106 to the recruiter company 102 providing the at least one job opening through the data communication network 114. In some other embodiments, the job matching system 112A is further operable to send the profiles of those candidates having maximum similarity with job description of the at least one job opening. The recruiter company 102 may then analyze the match score values, depending upon which the recruiter company 102 generates a feedback regarding the candidate 106. Further, the job matching system 112A is operable to receive the feedback regarding the given candidate 106 from the recruiter company 102. The job matching system 112A is operable to update the stored information based on the feedback from the recruiter company 102.

The job matching system 112A is further operable to rank the given candidate 106 to the at least one job opening by applying at least one ranking function. The term “ranking function” refers to a measure of ranking the candidate 106 based on the candidate's 106 profile (for example, his/her qualifications, experience, traits and skills, and so forth) and returns rank score values. Specifically, the at least one ranking function returns a value for ranking the candidate 106, including, but not limiting to, numbers, words, sets or combinations thereof.

The job matching system 112A is operable to recommend the at least one job opening to the given candidate 106. The at least one job opening is recommended based on the learning algorithm. The learning algorithm takes into consideration, all the values (i.e. the first set of values, the second set of values and the third set of values) as well as other information such as, feedback from the recruiter company 102, results and feed from other recruiter companies and other candidates with matching traits/profiles/answers and so forth. In an embodiment, the at least one job opening is recommended to the given candidate 106 in form of alerts, messages, notifications, emails, pop-ups and so forth. Further, the recommendations are provided instantly on online job boards or on computing device 104 of the candidate 106.

The job matching system 112A is further operable to manage the communications and data flows to and from the job matching system 112A, read the recommendations of the at least one job opening and the feedback from the recruiter company 102. The job matching system 112A is further operable to apply at least one learning function to the feedback information. The job matching system 112A is then operable to update the cross-correlation functions, the ranking functions as well as the professional profiles. The job matching system 112A is operable to make iterative recommendations of the at least one job opening to the given candidate 106 with an objective of getting the feedback into the job matching system 112A until final recommendation is defined arbitrarily or when the candidate 106 accepts a job offer from the recruiter company 102.

In an example, a recruiter company A is a law firm based in London operating in different areas, and after an attorney specialized in intellectual property joined as a partner, the recruiter company A started looking forward to develop their business in the area of intellectual property. The recruiter company A has a budget for a single position, while, typically starting a new division, requires positions for an assistant attorney (typically a young new graduate), support staff with experience in financials and administration and, critically, a business development/sales person to find clients for the business. Moreover, given the need for online present, IT skills or at least knowledge of web-based business is a must.

The job matching system 112A matches a candidate with the job requirements directly, using job descriptions and resume as support information, while the base for recommendation are aptitude, skills and personality of candidates. The job matching system 112A performs all above steps. As a result, the candidate ranked first in the recommendation ranking is a ‘law-degree drop-out’ who now runs his own coffee shop in an alternative neighborhood of Berlin, Germany. The support information for the recommendation algorithm is basic years in law school gave the candidate, skill needed for reading legal texts, while his school and university history, partly carried out in Poland, showed that he had very good grades in chemistry and mathematics. The coffee shop experience provided the necessary skills for administrative and financial management. The primary information for the recommendation algorithm is confirmation of the candidate's the entrepreneurship spirit and ability to work with and sell to people of different backgrounds. The candidate's history provided the confirmation of skills to work with legal texts (2.5 years at law school), ability to discuss technical matters—mathematical and chemistry skills can be important for discussing new inventions for patent applications. The job matching system 112A thus ranked candidate's overall personality characteristics as a near-perfect match for working environment and people of the recruiter company A.

Referring now to FIG. 1B, the job matching system 112B may be present in a cloud, i.e. on the data communication network 114 or on any network device in the data communication network 114.

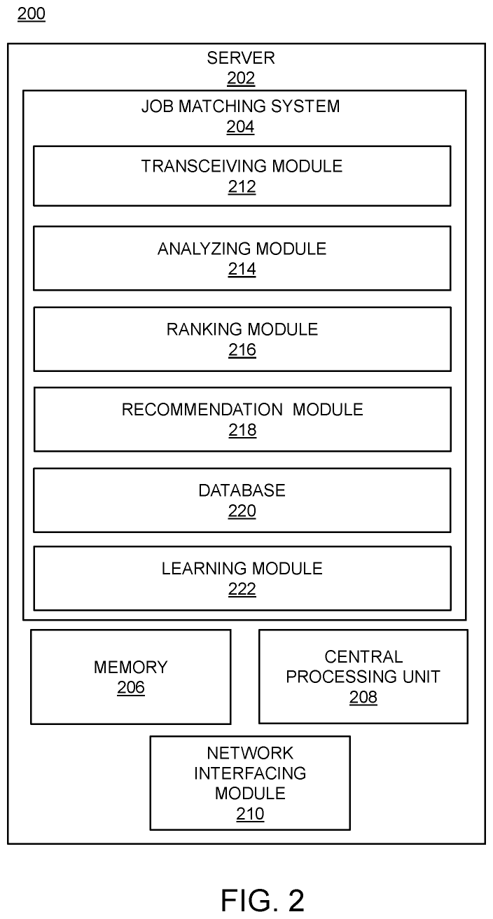

In FIG. 2, there is shown an illustration of a block diagram of a server 202, in accordance with an embodiment of the present disclosure. The server 202 may be a single device or may include more than one device including software, hardware, firmware, or combination of these. As shown, the server 202 primarily includes a job matching system 204, a memory 206, a central processing unit 208 and a network interface module 210. The job matching system 204 has a given candidate (such as the candidate 106) and a recruiter company (such as the recruiter company 102) connected thereto when in operation using respective computing devices (such as the computing devices 104 and 108) through a data communication network (such as the data communication network 114).

The job matching system 204 comprises a transceiving module 212, an analyzing module 214, a ranking module 216, a recommendation module 218, a database 220 and a learning module 222. The transceiving module 212 is operable to receive information describing the given candidate 106. Further, the transceiving module 212 is operable to receive information from the recruiter company 102. The information describing the given candidate 106 comprises the first set of information and the second set of information (described above). As aforementioned, the job matching system 204 is beneficially implemented using a block chain arrangement whose operation is coordinated through use of a distributed ledger arrangement, wherein the block chain arrangement is hosted in a data communication network including a plurality of data servers and user nodes that, when in operation, exchange data therebetween. Optionally, the distributed ledger arrangement supports operation of a block chain arrangement by use of encryption-hash verification of each new block added to the block chain that is verifiable from a previous block of the block chain to be bona fide. Optionally, each block represents a given job or a given candidate to ensure that a given job is not eventually allocated to more than one candidate, or a candidate is not allocated to more than one given job, unless job-share and/or part-time working is permitted in relation to the candidates and jobs. The distributed ledger keeps a record of the blocks of the block-chain. Data exchange in the block chain arrangement is beneficially implemented in an encrypted manner to protect personal information of job seekers, and to render the block chain arrangement resilient to malicious third-party hackers.

In the job matching system 204, data that is communicated and stored herein is beneficially in an encrypted format. More optionally, the information is provided in a corpus of data comprising a plurality of data parts, wherein mutually different encryption algorithms with mutually different encryption keys are employed to protect each of the plurality of data parts, so that the at least one recruiting company is susceptible to being provided with controlled access to at least one of the data parts by being provided with at least a subset of the encryption keys pertaining to the at least one of the data parts. Optionally, the encryption is time-limited so that the encryption keys provide only a time-limited access to the at least one data part.

The database 220 is operable to store the information describing the given candidate 106. Further, the database 220 is operable to store the information received from the recruiter company 102. Furthermore, the database 220 may be a single or multiple modules or devices including hardware, software, firmware, or a combination thereof.

The analyzing module 214 is operable to analyze the information describing the given candidate 106 and the recruiter company 102. Specifically, the analyzing module 214 is operable to assign the first set of values to the information describing the given candidate 106 by applying the at least one logic function to the received information. Furthermore, the analyzing module 214 is operable to define the second set of values based on the at least one logic function. The second set of values comprises the profile, the traits and the answers to questions asked from the given candidate 106. The analyzing module 214 is further operable to define profiles, desired traits in candidates, from the answers provided by the recruiter company 102. The analyzing module is further operable to generate the third set of values by applying the at least one cross correlation function to the first set of values and the second set of values. The third set of values are the match score values between the candidate profiles and the at least one job opening.

The transceiving module 212 is further operable to send the match score values associated with the given candidate 106 to the at least one recruiter company (such as the recruiter company 102) providing the at least one job opening. The transceiving module 212 is further operable to receive feedback regarding the given candidate 106 from the recruiter company 102. The analyzing module 214 then updates the database 220 based on the feedback from the recruiter company 102.

The ranking module 216 is operable to rank the given candidate 106 to the at least one job opening by applying the at least one ranking function. The recommendation module 218 is operable to recommend the at least one job opening to the given candidate 106. The learning module 222 is operable to manage the communications and data flows to and from the job matching system 204, reads the recommendations of the at least on job opening provided by the at least one recruiter company (such as the recruiter company 102) and the feedback from the recruiter company 102. The learning module 222 is further operable to apply the at least one learning function to the feedback information. The learning module 222 is then operable to update the at least one cross correlation function, the at least one ranking function as well as the profiles. The recommendation module 218 is operable to make iterative recommendations of the at least one job opening to the given candidate 106 with an objective of getting the feedback into the job matching system 204 until final recommendation is defined arbitrarily or when the candidate 106 accepts a job offer from the recruiter company 102.

The central processing unit 208 may include a single or multiple modules or devices including a software, hardware, firmware or combination of these, configured to execute instructions stored in a memory 206. The term “memory” refers to a single or multiple modules or devices including hardware, software, firmware, or combination of these, configured to store instructions that can be executed by other modules/devices. The network interfacing module 210 may enable the server 202 to establish connection with the data communication network 114 or/and with other network devices such as the computing devices 104 and 108 present in the data communication network 114.

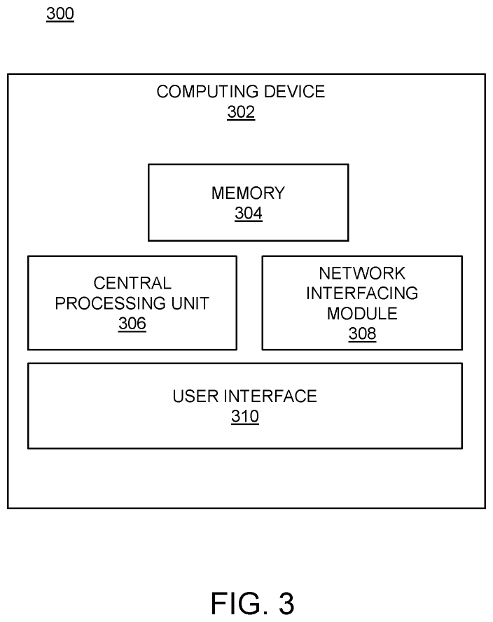

In FIG. 3, there is shown an illustration of a block diagram 300 of a computing device 302, in accordance with an embodiment of the present disclosure. As shown, the computing device 302 primarily includes a memory 304, a central processing unit (CPU) 306, a network interfacing module 308 and a user interface 310. Further, the memory 304, the central processing unit 306 and the network interfacing module 308 are similar in structure and function to the memory 206, the central processing unit 208 and the network interfacing module 210, respectively of the server 202 (explained in conjunction with FIG. 2).

In an embodiment, the user interface 310 (or a Graphical User Interface) is meant to be understood broadly as any hardware, or a combination of hardware and software, that enables the candidate 106 and the recruiter company 102 to interact with a system, program, or device. For example, the user interface 310 can include an interface on a display, such as a screen, of the computing devices 104 and 108 enabling the candidate 106 and the recruiter company 102 to interact with the computing devices 104 and 108.

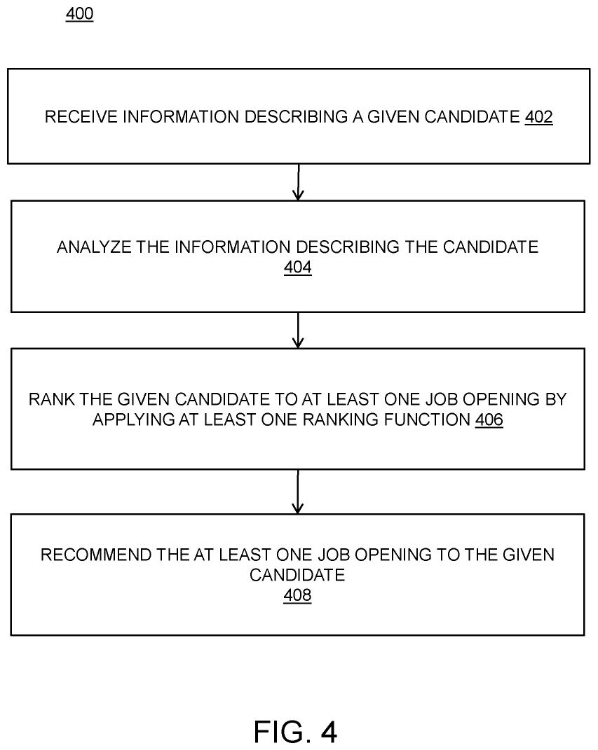

In FIG. 4, there are illustrated steps of a method 400 of mapping at least one job opening provided by at least one recruiter company (such as the recruiter company 102) to candidate profiles, in accordance with an embodiment of the present disclosure.

At a step 402, the information describing a given candidate is received. The given candidate and the recruiter company have respective computing devices, and the computing devices are communicably coupled in operation to a job matching system through a data communication network.

At a step 404, the information describing the candidate is analyzed.

At a step 406, the given candidate is ranked to the at least one job opening by applying at least one ranking function.

At a step 408, the at least one job opening is recommended to the given candidate.

Further, the steps 402 to 408 are only illustrative and other alternatives can also be provided where one or more steps are added, one or more steps are removed, or one or more steps are provided in a different sequence without departing from the scope of the claims herein. For example, the method 400 further includes storing the information describing the given candidate in a database. Furthermore, the method 400 includes sending match score values describing the given candidate to the at least one recruiter company providing the at least one job opening. Moreover, the method 400 includes receiving feedback regarding the given candidate from the at least one recruiter company. The method 400 further includes updating a database based on the feedback from the at least one recruiter company. As aforementioned, it will be appreciated that the steps 402 to 408, when implemented, beneficially employ data encryption to protect data that is exchanged in the method. Moreover, the method is beneficially implement using a block chain arrangement whose block entries are recorded and organised by a distributed ledger. Beneficially, data encryption is employed in the block chain arrangement to project sensitive personal data, thereby allowing controlled selective access to the data. Optionally, keys used in such encryption, and corresponding decryption, are time-limited so that old candidate data does not remain accessible over a long time period, therefore protecting person data of the job candidate, for example to comply with various national and international laws relating to limits of use of personal data.

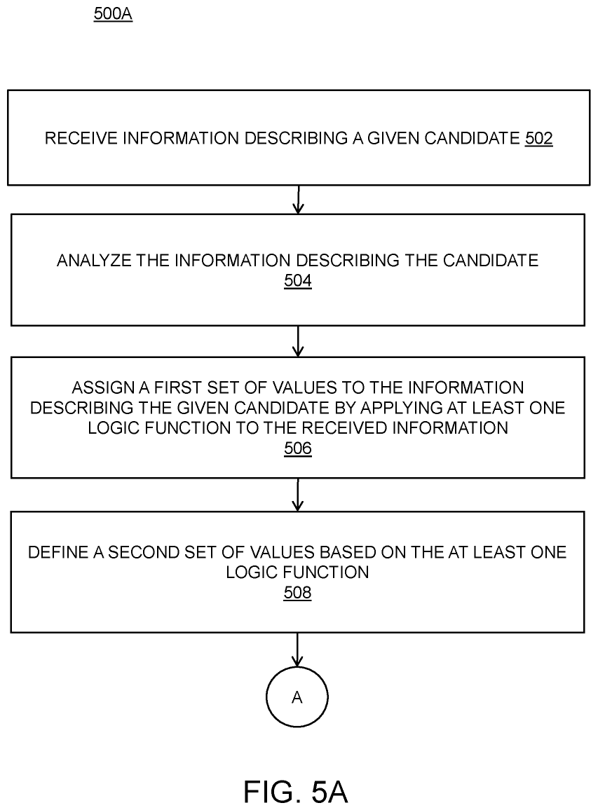

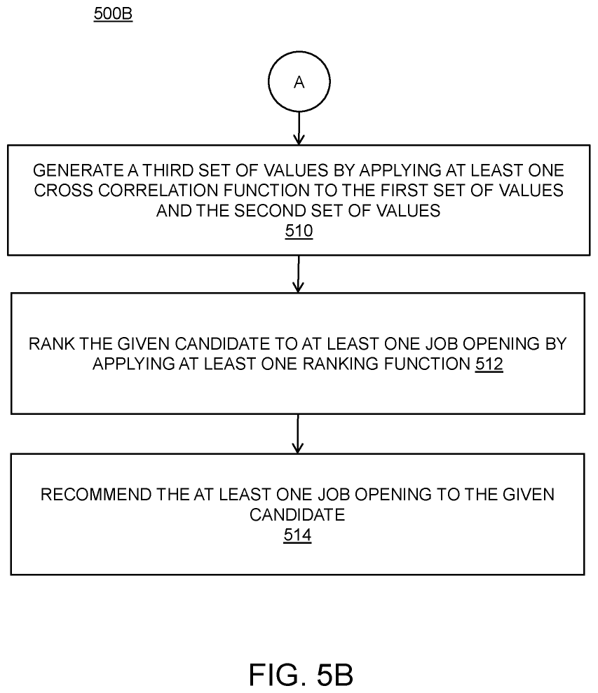

In FIGS. 5A-5B, there are shown illustrations of detailed steps of a method 500A-500B of mapping at least one job opening provided by at least one recruiter company (such as the recruiter company 102) to candidate profiles, in accordance with an embodiment of the present disclosure.

At a step 502, the information describing a given candidate is received. The given candidate and the recruiter company have respective computing devices, and the computing devices are communicably coupled in operation to a job matching system through a data communication network.

At a step 504, the information describing the candidate is analyzed.

At a step 506, a first set of values is assigned to the information describing the given candidate by applying at least one logic function to the received information.

At a step 508, a second set of values is defined based on the at least one logic function. The second set of values comprises profile, traits and answers to questions asked from the given candidate.

At a step 510, a third set of values is generated by applying at least one cross correlation function to the first set of values and the second set of values. The third set of values are match score values between the candidate profiles and the at least one job opening.

At a step 512, the given candidate is ranked to the at least one job opening by applying at least one ranking function.

At a step 514, the at least one job opening is recommended to the given candidate.

As aforementioned, the method 500A-500B is beneficially implemented using a block chain arrangement whose operation is coordinated through use of a distributed ledger arrangement, wherein the block chain arrangement is hosted in a data communication network including a plurality of data servers and user nodes that, when in operation, exchange data therebetween. Optionally, the distributed ledger arrangement supports operation of a block chain arrangement by use of encryption-hash verification of each new block added to the block chain that is verifiable from a previous block of the block chain to be bona fide. Optionally, each block represents a given job or a given candidate to ensure that a given job is not eventually allocated to more than one candidate, or a candidate is not allocated to more than one given job, unless job-share and/or part-time working is permitted in relation to the candidates and jobs. The distributed ledger keeps a record of the blocks of the block-chain. Data exchange in the block chain arrangement is beneficially implemented in an encrypted manner to protect personal information of job seekers, and to render the block chain arrangement resilient to malicious third-party hackers.

In the method 500A-500B, data that is communicated and stored herein is beneficially in an encrypted format. More optionally, the information is provided in a corpus of data comprising a plurality of data parts, wherein mutually different encryption algorithms with mutually different encryption keys are employed to protect each of the plurality of data parts, so that the at least one recruiting company is susceptible to being provided with controlled access to at least one of the data parts by being provided with at least a subset of the encryption keys pertaining to the at least one of the data parts. Optionally, the encryption is time-limited so that the encryption keys provide only a time-limited access to the at least one data part.

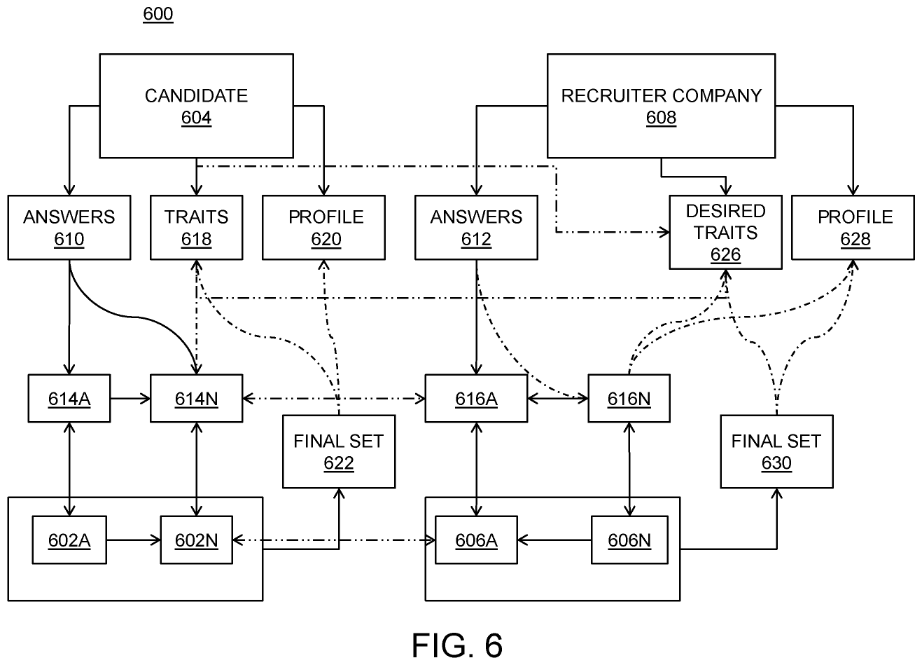

In FIG. 6, there is shown an illustration of an exemplary implementation 600 of information flow in a system (such as the system 100A-100B) for mapping at least one job opening provided by at least one recruiter company to candidate profiles, explained in conjunction with the FIGS. 1-5, in accordance with an embodiment of the present disclosure.

The job matching system 112A (shown in FIG. 1A) asks a set of questions 602A-602N from a candidate 604 and a set of questions 606A-606N from a recruiter company 608.

The candidate 604 and the recruiter company 608 provides answers 610, and 612 to the set of questions 602A-602N and the set of questions 606A-606N, respectively. The answers 610 gets stored in a set of answers 614A-614N, and the answers 612 gets stored in a set of answers 616A-616N.

The job matching system 112A extracts traits 618 and profiles 620 of the candidate 604 from resumes provided by the candidate 604 and the answers 610 provided by the candidate 604. The traits 618 and the profiles 620 of the candidate 604 are stored in a final set 622.

The job matching system 112A further extracts desired traits 626 and desired profiles 628 by the recruiter company 608 from job descriptions provided by the recruiter company 608 and the answers 612 provided by the recruiter company 608. The desired traits 626 and the desired profiles 628 are stored in a final set 630. The information stored in the final sets 622 and 630 are compared to find the match score values therebetween.

The present disclosure provides a method and a system of mapping at least one job opening provided by at least one recruiter company to candidate profiles. The disclosed method and system determine traits of candidates, such as personality characteristics, personal features such as being introvert and so forth, by asking a set of questions from the candidate. The disclosed method and system further take into consideration these traits while finding a job for the candidates. Furthermore, the disclosed method and system rank the candidates to different job openings, and then recommends the job openings to the high ranked candidates. Moreover, the disclosed method and system receive feedback regarding the candidate from the recruiter company, which helps the system to update the information.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

1.-16. (canceled)

17. A method for mapping at least one job opening provided by at least one recruiter company to candidate profiles, the method comprising:
receiving information describing a given candidate;
analyzing the information describing the candidate, wherein the analyzing comprises:
assigning a first set of values to the information describing the given candidate by applying at least one logic function to the received information;
defining a second set of values based on the at least one logic function, wherein the second set of values comprises profile, traits and answers to questions asked from the given candidate; and
generating a third set of values by applying at least one cross correlation function to the first set of values and the second set of values, wherein the third set of values are match score values between the candidate profiles and the at least one job opening;
ranking the given candidate to the at least one job opening by applying at least one ranking function; and
recommending the at least one job opening to the given candidate.

18. The method of claim 17, further comprising storing the information describing the given candidate.

19. The method of claim 18, further comprising storing the information described the given candidate in an encrypted format.

20. The method of claims 17 wherein the information describing the given candidate comprises a first set of information, wherein the first set of information comprises at least one of designation, experience, current salary, expected salary and qualifications.

21. The method according to claim 17, wherein the information describing the given candidate comprises a second set of information, wherein the second set of information comprises personal traits and skills of the candidate.

22. The method according to claim 17, further comprising sending the match score values describing the given candidate to the at least one recruiter company providing the at least one job opening.

23. The method according to claim 17, further comprising receiving feedback regarding the given candidate from the at least one recruiter company.

24. The method according to claim 17, further comprising updating the information based on the feedback from the at least one recruiter company.

25. A system of mapping at least one job opening provided by at least one recruiter company to candidate profiles, the system comprising:
a server having a job matching system, wherein the job matching system has a given candidate and the recruiter company connected thereto when in operation using respective computing devices through a data communication network, the job matching system comprises:
a transceiving module for receiving information describing the given candidate;
an analyzing module for:
analyzing the information describing the given candidate;
assigning a first set of values to the information describing the given candidate by applying at least one logic function to the received information;
defining a second set of values based on the at least one logic function, wherein the second set of values comprises profile, traits and answers to questions asked from the given candidate; and
generating a third set of values by applying at least one cross correlation function to the first set of values and the second set of values, wherein the third set of values are match score values between the candidate profiles and the at least one job opening;
a ranking module for ranking the given candidate to the at least one job opening by applying at least one ranking function; and
a recommendation module for recommending the at least one job opening to the given candidate.

26. The system of claim 25, wherein the job matching system further comprises a database for storing the information describing the given candidate.

27. The system of claim 26, wherein the system, when in operation, stores the information described the given candidate in an encrypted format.

28. The system of claim 25, wherein the information describing the given candidate comprises a first set of information, wherein the first set of information comprises at least one of designation, experience, current salary, expected salary and qualifications.

29. The system of claim 25, wherein the information describing the given candidate comprises a second set of information, wherein the second set of information comprises personal traits and skills of the given candidate.

30. The system as claimed in claim 25, wherein the transceiving module is further operable to send the match score values associated with the given candidate to the at least one recruiter company providing the at least one job opening.

31. The system as claimed in claim 25, wherein the transceiving module is operable to receive feedback regarding the given candidate from the at least one recruiter company.

32. The system as claimed in claim 25, wherein the analyzing module is operable to update the information based on the feedback from the at least one recruiter company.
